(19) United States
(12) Patent Application Publication
(10) Pub. No.: US 2008/0110095 A1
(43) Pub. Date: May 15, 2008

(54) Shutter

(75) Inventor: Ming Nien, Taichung (TW)

Correspondence Address: BRUCE H. TROXELL, SUITE 1404, 5205 LEESBURG PIKE, FALLS CHURCH, VA, 22041, US

(73) Assignee: NIEN MADE ENTERPRISE CO., LTD.

(21) Appl. No.: 11/599,613

(22) Filed: Nov. 15, 2006

(51) Int. Cl. E06B 7/08

(52) U.S. Cl. 49/74.1

(57) ABSTRACT

A shutter includes an upper block, a lower block, plural slats and plural vertical blocks. The upper block, the lower block, the slats and the vertical side blocks are all provided with an inner block fixed with an upper veneer, a lower veneer, a front veneer and a rear veneer. The inner block is a made of hard plywood, not easily deform to keep the shutter not easily deformed. The upper block, the lower block and each slat are provided with a recessed step so that the slats can fit with the upper block and the lower block for shutting out light steadily in case of the slats are changed in their angles.

### BACKGROUND OF THE INVENTION

1. Field of the Invention

This invention relates to a shutter, particularly to one with its parts respectively formed with an inner block and a front, a rear, an upper and a lower veneer fixed around the inner block so that parts such as an upper block, a lower block, plural vertical side blocks and slats are not apt to easily disfigure.

2. Description of the Prior Art

Traditional shutters are generally made of wood or plastic, but natural wood can contain and absorb water, apt to disfigure or deform owing to sunshine or rain. Then slats may become difficult to change their angle, shorting its service life. As to those made of plastic, they may not be easy to deform, but does not have enough strength. A conventional shutter shown in FIG. 1 has an vertical side block 1, which is provided with an inner hollow for receiving an inner block 2 made of plywood, ordinary wood block or metal for reinforcing the strength of the vertical side block 1 for prolonging its service life.

However, the conventional shutter has the slats shaped elongate and rectangular, hardly to contact closely one another in case moved to become vertical for shutting out light, with a bit gap formed, having poor quality.

### SUMMARY OF THE INVENTION

The feature of the invention is the structure of an upper block, a lower block, plural slats and plural vertical side blocks of a shutter. They all consist of an inner block covered with a front veneer, a rear veneer, an upper veneer, and a lower veneer to made the shutter not easily deformed. Further, the material of the inner block is hard plywood, having a high strength to resist deforming so as to acquire optimal effect for shutting out light. Further, the upper block, the lower block and the plural slats are all provided with a recessed step at a preset location so that the slats can fit closely with the upper and the lower block in case of changed their angle and closed up for shutting out light. Moreover, the location of the recessed steps is at a sandwiched point, not easily deformed, with the service life prolonged. Besides, a light hampering plate can be fixed at a connecting line of two vertical side blocks abutting to each other, or one side of the two vertical side blocks is provided with a recessed step to fit with each other.

### BRIEF DESCRIPTION OF DRAWINGS

This invention will be better understood by referring to the accompanying drawings, wherein:

FIG. 1 is a perspective view of a vertical side block of a conventional shutter;

FIG. 2 is a perspective view of a shutter in the present invention;

FIG. 3 is a cross-sectional view of an upper block of the shutter in the present invention;

FIG. 4 is a cross-sectional view of a slat of the shutter in the present invention;

FIG. 5 is a cross-sectional view of a lower block of the shutter in the present invention;

FIG. 6 is a cross-sectional view of a vertical side block of the shutter in the present invention;

FIG. 7 is a cross-sectional view of the shutter closed up in the present invention;

FIG. 8 is a side view of a second embodiment of a vertical side block in the present invention;

FIG. 9 is a side view of a third embodiment of a vertical side block in the present invention; and,

FIG. 10 is a perspective view of a control rod installed at a side of the shutter in the present invention.

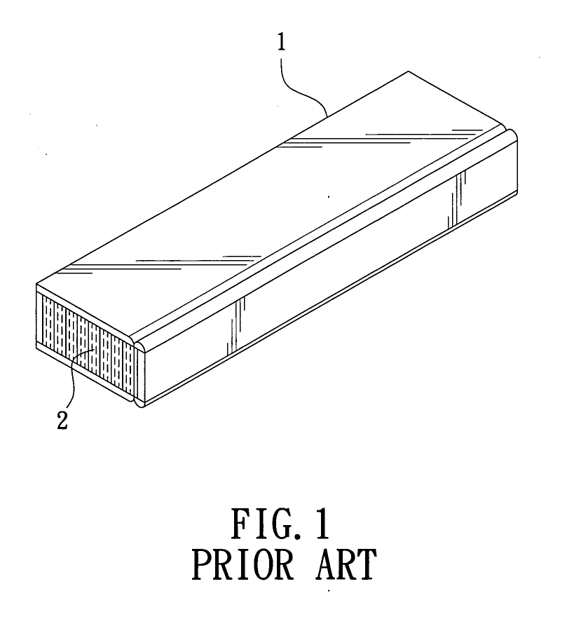

### DETAILED DESCRIPTION OF THE PREFERRED EMBODIMENT

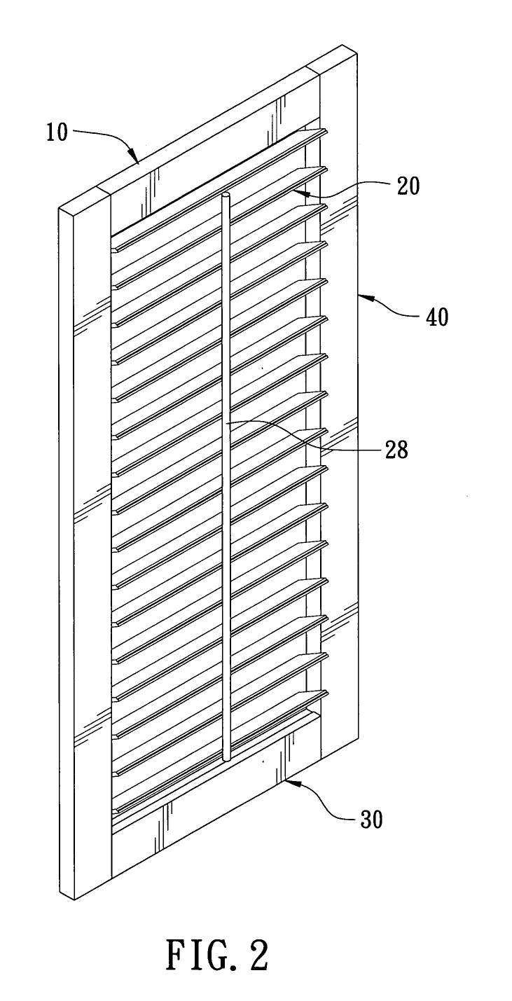

A preferred embodiment of a shutter in the present invention, as shown in FIG. 2, includes an upper block 10, plural slats 20, a bottom block 30, and plural vertical side blocks 40 as main components.

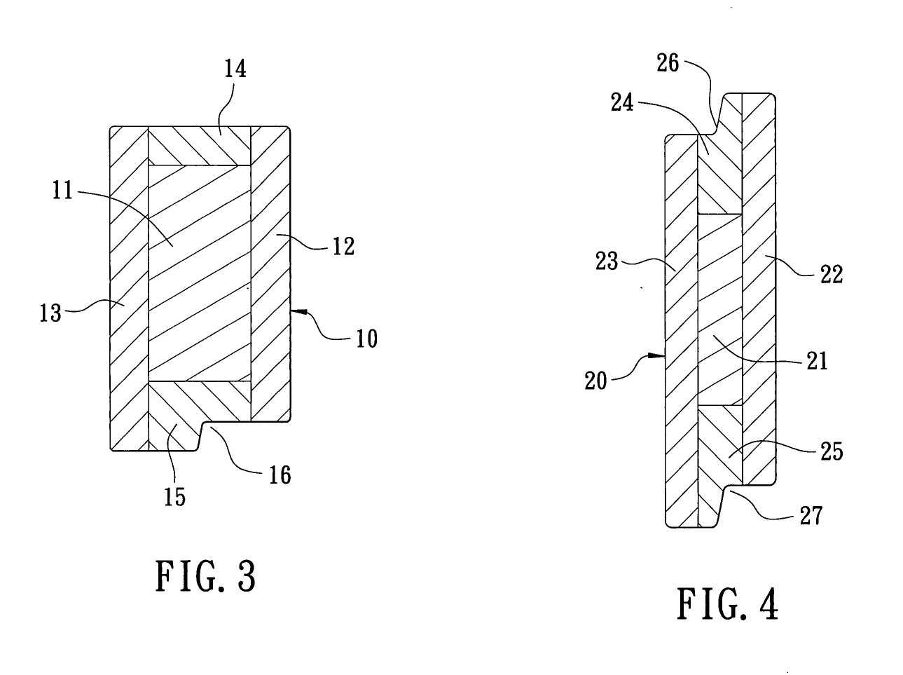

The upper block 10, as shown in FIG. 3, is composed of an inner block 11, a front veneer 12, a rear veneer 13, an upper veneer 14 and a lower veneer 15 fixed around the inner block 11. The inner block 11 is made of a layer of plywood of comparative hardness, or of plural layers of plywood. The front veneer 12, the rear veneer 13, the upper veneer and the lower veneer 15 are all of wood. Further, the lower veneer 15 is formed with a recessed step 16 in the lower side between the front veneer 12 and the rear veneer 13, with the recessed step 16 being flush with the lower side of the front veneer 12, which is a little higher than the lower side of the rear veneer 13. The depth of the step recess 16 is half of the thickness of the lower veneer 15.

Next, the plural slats 20 shown in FIG. 4, respectively consists of an inner block 21 made of the same material as that of the inner block 11 of the upper block 10, a front veneer 22, a rear veneer 23, a lower veneer 24 and an upper veneer 25 fixed around the inner block 21. The front veneer 22, the rear veneer 23, the lower veneer 24 and the upper veneer 25 are made of the same material as that of the upper block 10. The upper veneer 24 is provided with a recessed step 26, which is flush with the upper side of the rear veneer 23, which is a little lower than the upper side of the front veneer 22. The lower veneer 25 is provided with a recessed step 27, which is flush with the lower side of the front veneer 22, which is a little high than the lower side of the rear veneer 23. Further, the upper recessed step 26 and the lower recessed step 27 have a depth half of the thickness of the upper veneer 24 and the lower veneer 25.

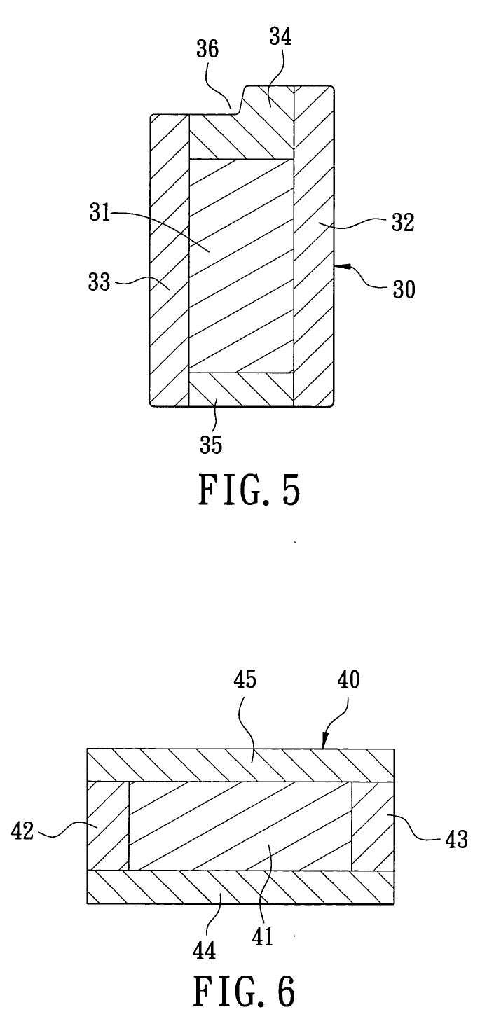

Next, the lower block 30 shown in FIG. 5 consists of an inner block 31 made of the same material as that of the inner block 11 of the upper block 10, a front veneer 32, a rear veneer 33, an upper veneer 34 and a lower veneer 35 fixed around the inner block 31. The front veneer 22, the rear veneer 23, the upper veneer 24 and the lower veneer 25 are made of the same material as that of the upper block 10. The upper veneer 34 is provided with a recessed step 36, which is flush with the upper side of the rear veneer 33, with the depth being half of the thickness of the upper block 34.

The plural vertical blocks 40 shown in FIG. 6 respectively consist of an inner block 41 made of the same material as that of the inner block 11 of the upper block 10, a right veneer 42, a left veneer 43, a front veneer 44 and a rear veneer 45 fixed around the inner block 41. The right veneer 42, the left veneer 43, the front veneer 44 and the rear veneer 45 are all made of the same material as that of the upper block 10.

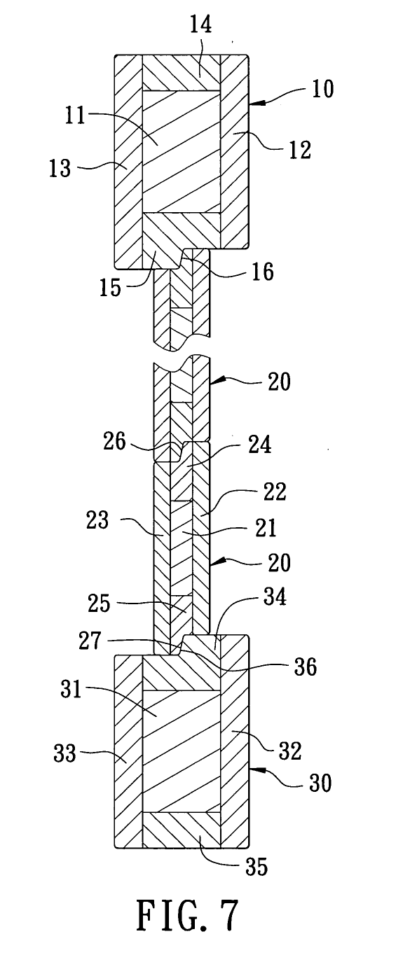

Next, FIG. 7 shows the shutter in the invention in a closed condition, with the plural slats 20 kept upright or vertical by handling a control rod 28 combined with the slats 20, which are changed in their angles for shutting out light totally. The recessed steps 26, 27, 36, 37, 46 and 47 of the slats 20, the upper block 30 and the lower block 4 are useful for enabling the slats 20 to change their angles smoothly for prohibiting light from shooting through the shutter.

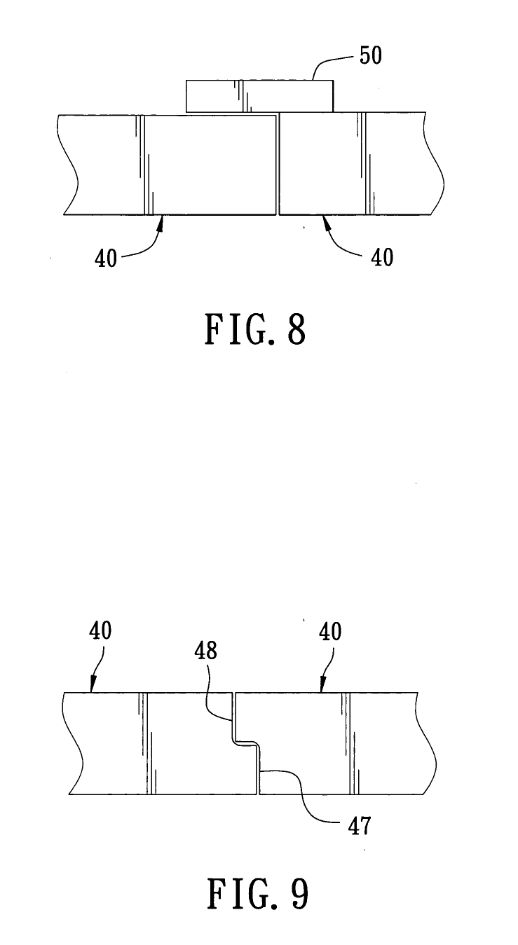

Next, as shown in FIG. 8, when one shutter is positioned just next to another shutter, a light hampering plate 50 can additionally be fixed on a contacting line of the rear side of two abutting vertical side blocks 40 of the two shutters for preventing light from shooting through a gap between the two abutting vertical side blocks 40.

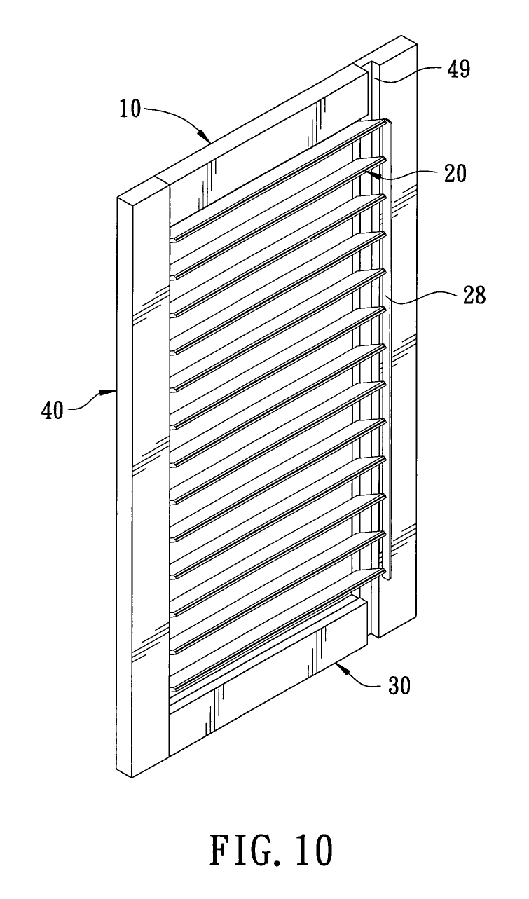

Moreover, FIG. 9 shows another preferred embodiment of a vertical side block 40, which has a recessed step 47 and 48 respectively for two abutting vertical side blocks 40 to fit together closely for hampering light from shooting through a gap between the two neighboring vertical side blocks 40 of two shutters built side by side.

Next, FIG. 10 shows a control rod 28 installed at a side of the shutter and combined with the slats for moving the slats 20 instead of at a centerline of the shutter, when a single shutter is used. Then the vertical side block 40 abutting to the control rod 28 is provided with a recessed step 49 at two ends to form a space for the control rod 28 to move therein in case of moving the slats 20.

In addition, when the control rod 28 installed at a side of the shutter is used for plural shutters positioned side by side, the vertical side block 40 abutting the control rod 28 is provided with the recessed step 49, and the other vertical side block 40 is a common vertical side block without any recessed step 49, and the central two abutting vertical side blocks 40 are provided with the recessed steps 47 and 48, or can be with no recessed step but added with the light hampering plate 50.

The invention has the follow advantages as can be understood from the foresaid description.
1. The slats 20, the upper block 10 and the lower block 30 are all provided with the recessed step 26, 16 or 36, enabling the slats 20 can fit with the upper and the lower block 10 and 30 in case of changing its angle so that light can not shoot through the shutter.
2. The recessed steps 16, 26, 27, 36, 47 and 48 cannot split or deform even after a long term of use, as they are respectively located at a sandwiched position.
3. The inner block 21 cannot be deformed by heat or heavy weight, because it is made of hard plywood having a high strength against deformation.
4. The plural vertical side blocks 40 are provided with the recessed step 47, preventing light from shooting through any gap between two ones, and the light hampering plate 50 can shut out light if used.
5. When the control rod 28 is positioned at a side of a shutter, the abutting vertical side block 40 is provided with a space for the control rod to move in for acquiring optimal effect.

While the preferred embodiment of the invention has been described above, it will be recognized and understood that various modifications may be made therein and the appended claims are intended to cover all such modifications that may fall within the spirit and scope of the invention.

What is claimed is:

1. A shutter comprising of an upper block, a lower block, and plural slats and two vertical side blocks; said upper block, said lower block and said two vertical side blocks forming a frame of said shutter, said plural slats installed between said two vertical side blocks and spaced apart horizontally between said upper block and said lower block, said slats combined with a control rod and possible to change their angle by said control rod so as to shut out light in various degrees:
said upper block consisting of a lengthwise inner block, a front veneer, a rear veneer, an upper veneer and a lower veneer fixed around said inner block, said upper block having its lower veneer formed with a recessed step, which is flush with a lower end of said front veneer;
said plural slats horizontally arranged and spaced apart properly in said frame of said shutter, each slat consisting of an inner lengthwise block, a front veneer, a rear veneer, an upper veneer and a lower veneer fixed around said inner block, said front veneer formed with a recessed step that is flush with one side of said lower veneer, said rear veneer formed with a recessed step that is flush with one side of said upper veneer;
said lower block consisting of an inner lengthwise block, a front veneer, a rear veneer, a an upper veneer and a lower veneer fixed around said inner block, said upper veneer formed with a recessed step that us flush with an upper side of said rear veneer; and,
said vertical side blocks respectively consisting of an inner block, a left veneer, a right veneer, a front veneer and a rear veneer fixed around said inner block.

2. The shutter as claimed in claim 1, wherein said recessed step of said upper block has a depth half of the thickness of said lower veneer.

3. The shutter as claimed in claim 1, wherein said recessed step of said upper veneer and said lower veneer of each said slat has a depth half of said upper veneer and said lower veneer respectively.

4. The shutter as claimed in claim 1, wherein said recessed step of said lower block has a depth half of said upper veneer.

5. The shutter as claimed in claim 1, wherein said vertical side block abutting to said control rod is provided with a lengthwise recessed step respectively in two ends when said control rod is installed at one vertical side of said shutter.

6. The shutter as claimed in claim 1, wherein a light hampering plate is fixed on a lengthwise connecting line of rear sides of two of said vertical side blocks abutting to each other for preventing light from shooting in through a gap formed by said connecting line when two of said shutters are positioned side by side.

7. The shutter as claimed in claim 1, wherein when two of said shutters are installed side by side, a first of two abutting vertical blocks is provided with a recessed step directed toward a second of said abutting vertical blocks at two ends respectively, and the second of said two abutting vertical blocks is provided with a recessed step at two ends respectively in corresponding to said recessed steps of said first abutting vertical block, so that said two abutting vertical blocks may fit with each other closely.
